(19) United States
(12) Patent Application Publication
(10) Pub. No.: US 2017/0147766 A1
(43) Pub. Date: May 25, 2017

(54) National Walk-in Medical Clinical Locator

(71) Applicants: Stephen Lino Schiavone, Fountain Hills, AZ (US); Kelly Ray Summers, Scottsdale, AZ (US); Michael Robertson, Chandler, AZ (US)

(72) Inventors: Stephen Lino Schiavone, Fountain Hills, AZ (US); Kelly Ray Summers, Scottsdale, AZ (US); Michael Robertson, Chandler, AZ (US)

(21) Appl. No.: 15/249,441

(22) Filed: Aug. 28, 2016

(51) Int. Cl. G06F 19/00; G06F 17/30

(52) U.S. Cl. CPC G06F 19/328; G06F 19/324; G06F 17/30864; G06F 17/3053; G06F 19/322; G06Q 10/06393

(57) ABSTRACT

The CareMed, National Walk-In Medical Clinical Locator provide consumers global access to healthcare provider services regardless of their affiliation or membership to any one caregivers network. A single point of intelligent access removes the need for consumers to submit generic searches or make arbitrary decisions with little if any basis in fact. Additionally, it avoids the need for consumers to register or enroll in any one specific provider care network. The weighted list of provider recommendations utilizes a wide range of propriety decision-based variables to recommend services to the benefit of the consumer and facilitate inter-provider competitiveness thereby increasing the availability of care providers.

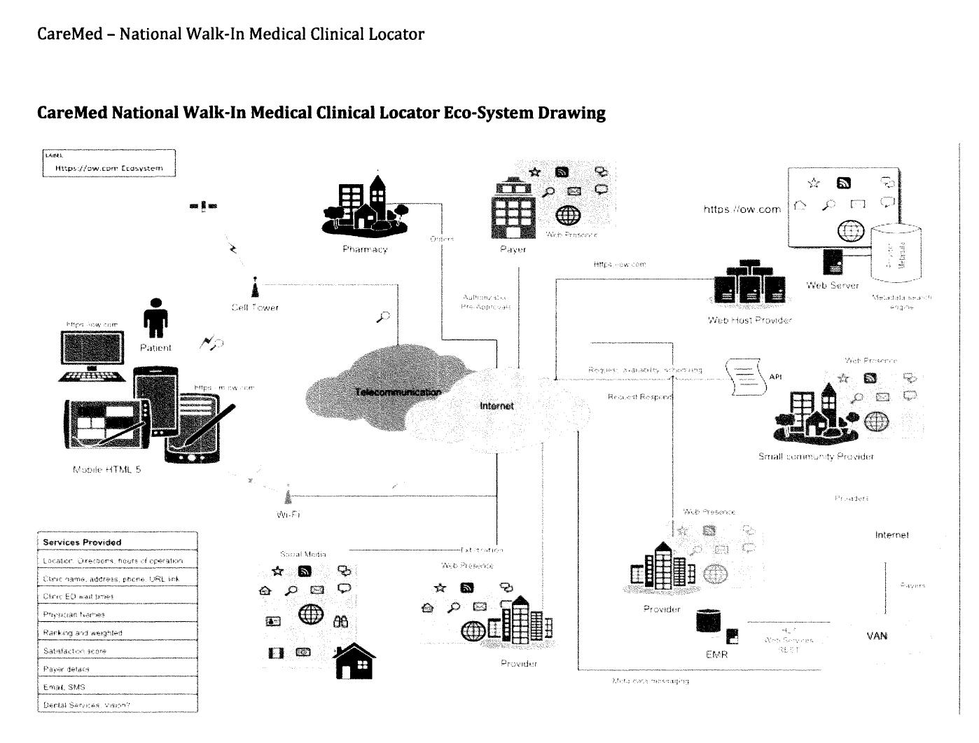

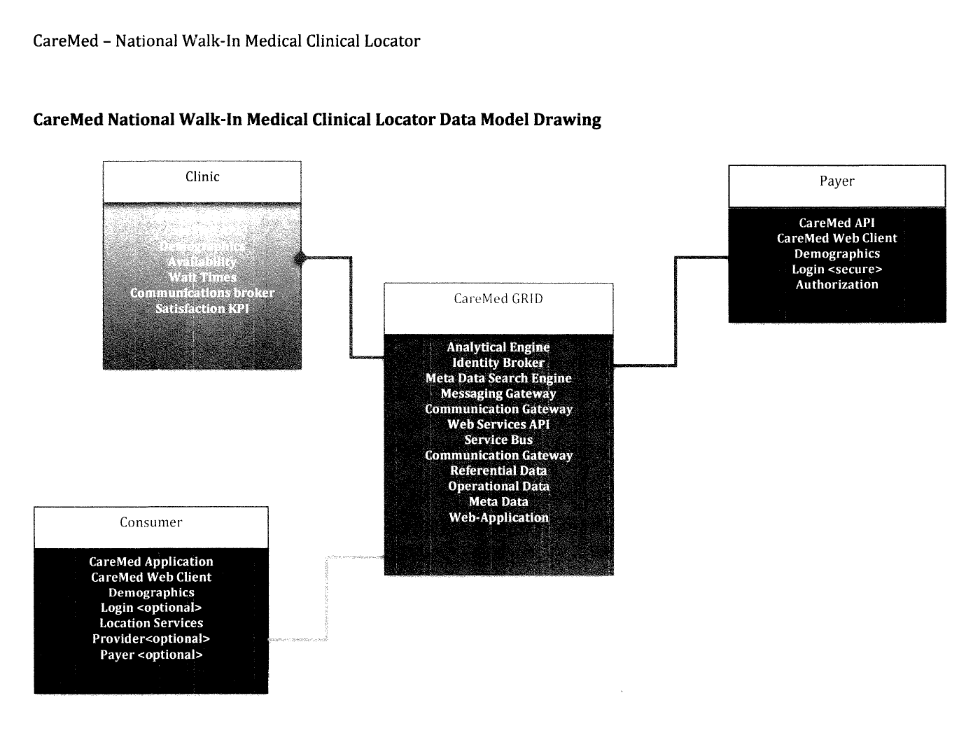

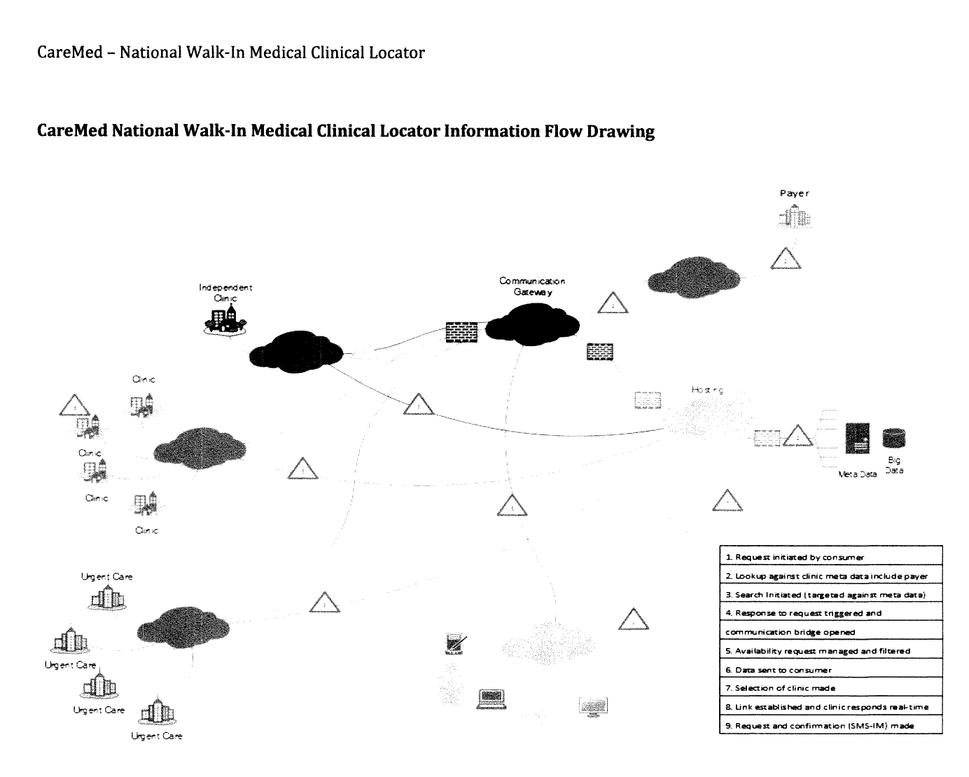

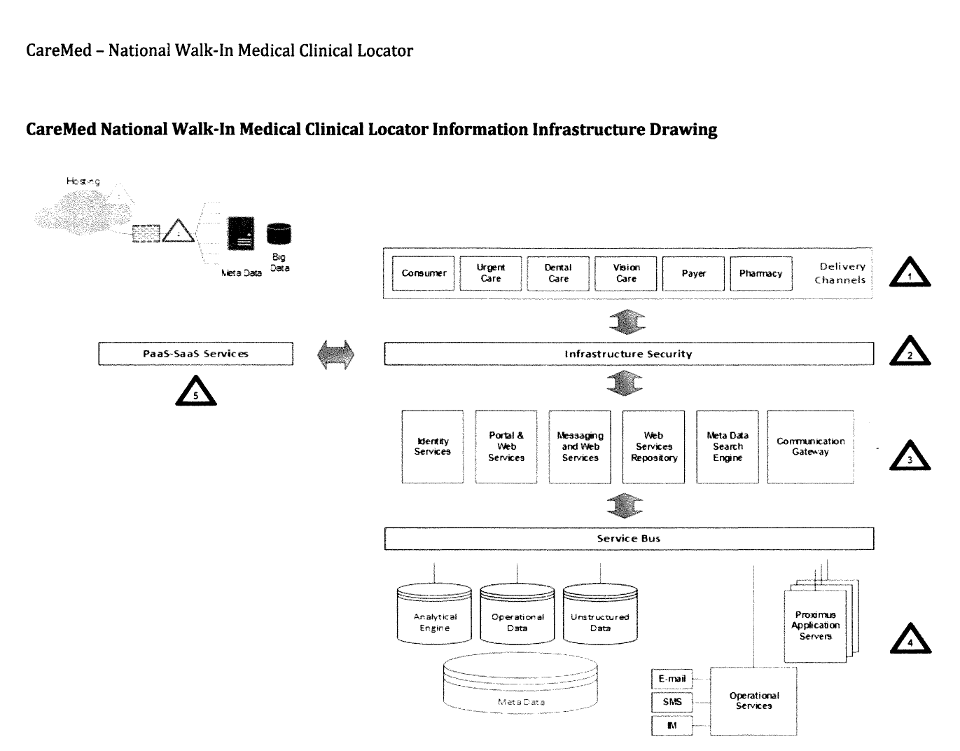

The following outlines the technical design and architecture enabling and supporting the functional features and capabilities of the application CareMed-National Walk-In Medical Clinical Locator. The described architecture provides unique and innovative component-level services in the form of: integration services, data services, analytical services, and action-oriented (event) services. Services provided by CareMed enable complex real-time connection and interaction between the entities: [1] consumer (patient), [2] provider of medical care (urgent and critical care), [3] payers, (insurance authorization and pre-authorization) and [4] Pharmacy. The services provided by CareMed will capture geo-spatial and demographic data for all entities.

Technically, the CareMed infrastructure is a highly available, highly performing, and secure information broker and knowledge grid. The CareMed grid is dynamic—it creates paths and connections between entities triggered by meta-data of providers and payer, and consumer requests and torn down once demand no longer exists. The services enabled by a connection maybe informational or action oriented triggering events within the systems of the connected entities.

The asynchronous nature of the interaction optimizes the demand requests initiated by the consumer against the scarce resources available from the providers of clinical care. The important benefit of CareMed is the optimization of healthcare delivery organization's supply chain resources against the unpredictable demand patterns of consumers. Unlike other demand and supply chain models within the retail, wholesale, manufacturing, and logistics sectors, CareMed ensures the timely placement of patients based on the services, availability, proximity, wait times, performance key performance indicators (KPIs) of providers of care. Additionally CareMed creates an ecosystem of high interoperability between the provider's computer systems—electronic medical record (EMR) enabling a closed loop transaction from enquiry, scheduling, and confirmation.

The CareMed analytical engine that generates suggestions or recommendations to the consumer utilizes propriety, multiple-criteria decision algorithm (MCDA). MCDA creates a mathematically defined “decision space” that corresponds to a set of possible decisions that are available to CareMed based on specific decision criteria or attributes from which a set of alternatives are derived.

Recommendation and order of preference of clinics within CareMed' search return lists considers a wide range of variables such as customer satisfaction rating, historical performance, availability times, proximity, geospatial data, response times, and wait times (if available), in-net and out-of-net considerations (depending on whether the consumer is anonymous or a registered user. Simply stated the MCDA provides the best alternative from a set of competing alternatives using optimization algorithms.

The search string does not consider provider preference or affiliation of health delivery organizations. Unlike generic Internet search engines, CareMed returns unbiased specific answers to a consumer's request providing as complete a response to enable a consumer to make a placement decision. Speed of response and confirmed action with a minimum of consumer interaction with the provider is the key driver.

### CareMed Infrastructure Specification

The creation of consumer, provider and payer knowledge is achieved via the construction of a highly dynamic information-driven grid, achieved from the ability to bind (just-in-time) a request for urgent care to a provider that is available and convenient to both parties whereby patient and provider outcome derives a mutually beneficial arrangement (win-win). Injecting payer information facilitates improved claims management providing timely processing of claims and reimbursement to both patient and provider. Value is defined from these interactions.

CareMed provides significant benefits to all entities involved in the interaction brokered by the CareMed's information grid:
Patients, Immediate response to requests for clinical services directing patients to clinics as opposed to ER (outpatients vs. inpatients)
Provider, Increased consumer throughput and increase in added value services (pharmacy, and where appropriate household goods)
Payers, Improved claims management, targeting in-net clinics on behalf of consumers, invoking pre-authorization and authorization process. Consumer, provider, and payer benefit from the interaction
Community, improving access to clinics in a timely manner

### Design

The technical design for CareMed will provide:
1. Provide a secure and private real-time patient to clinic interaction via a specialized application (mobile application, web client or agent-API)
2. Secure connection will adhere to the concepts of Confidentiality, Integrity, and Availability
3. Security must manage all layers within the transaction from communication, transport and data
4. Use of encryption and digital certificates is required for all transactions passed between consumer, CareMed and provider
5. The consumer to provider interaction will allow for the exchange of availability windows within appointment scheduling between consumer and provider(s); and allow the ability to reserve and confirm an available appointment for the chosen provider. This must occur in real-time
6. The interoperability of CareMed will connect the CareMed (consumer) client to disparate computer systems of provider, payer and pharmacy entities via a CareMed propriety agent, API (Web services) or secure web client
7. Recommendation to a consumer request is accomplished via the CareMed

Analytic Engine that considers geospatial data, provider data, payer data, and diverse unstructured data
8. Reuse of CareMed services is enabled through a secure consumer registration process. Personally identified data is securely held within CareMed
9. The CareMed information grid is engineered on a highly flexible and scalable open source propriety cloud platform
10. Enable real-time interaction between consumer and provider-payer via instant messaging and chat.
11. Enable confirmation of a medical transaction, appointment confirmation and appointment change or cancelation
12. Development of web services and APIs library to connect to disparate medical and payer systems
13. CareMed's architectural layers will comprise of
   a. Web and Application Servers (Portal Service)
   b. Non-relational data base engine (Operational and Non-Operational Data)
   c. Web Services, API repository and registration engine
   d. Identity Server
   e. Service bus
   f. Cloud communications Gateway
   g. Mobile Server
   h. Mobile (platform independent) CareMed application
   i. CareMed Web Client
   j. CareMed Client agent
   k. CareMed Web Services API agents
   l. CareMed Analytical Engine
   m. CareMed Metadata engine

The application, infrastructure, and integration layers are derived from the functional and architectural design goals. Some of the required architectural design principles of this architecture are listed as follows:
1. Availability of the CareMed service is considered high viz. 0.9999
2. Architecture must support non-disruptive maintenance schedule
3. Access is secured and supports stringent Access, Authentication, and Authorization policies. All access is audited through an accounting mechanism
4. Any PHI information made available is secured and follows encryption at rest and in motion.
5. Access to provider systems is via Web Services or API adapters and is non-intrusive
6. Architecture must support propriety medical and clams-based systems in a secure manner via trusted web services, portals or agents
7. Communication—transport layer is secured supporting encryption, non repudiation principles and confidentiality, integrity and available policies
8. Operational, unstructured data, and meta data is secured and encrypted
9. CareMed services are hosted in a secure Tier III cloud
10. CareMed Technical architecture is hosted on tier 1 technologies to ensure performance, resilience and availability of services

CareMed National Walk-In Medical Clinical Locator specification addresses the following scenarios:

Scenario 1: Utilizing SMS
1. CareMed application is deployed to the mobile phones of consumers via a self service portal
2. Meta data is captured for all care providers (viz. demographics) and processed and stored within CareMed
3. Meta Data is regularly refreshed, cleansed and updated
4. Consumer triggers a search request through the application or portal on the CareMed Web Site
5. Request search string locates providers (real-time) within the locale of the consumer stored within the CareMed meta-data repository
6. Clinics interested will provide CareMed with availability requirements
7. Results are presented based on multiple criteria decision analysis
8. Consumer selects clinic
9. Confirmation is provided in real time between clinic and consumer brokered by CareMed via secured SMS
10. Directions to the selected clinic is provided

Benefits
1. Only clinics presented to the consumer with guaranteed availability slots for ad hoc appointments are presented minimizing the number of clinics presented to a consumer
2. Patient satisfaction increases
3. Providers presented to the consumer will have an increased number of appointments scheduled—increased revenue

Scenario 2: Utilizing SMS and Chat
1. CareMed application is deployed to the mobile phones of consumers via a self service portal
2. Meta data is captured for all care providers (viz. demographics) and processed and stored within CareMed achieved by the use of APIs
3. Meta Data is regularly refreshed, cleansed and updated
4. Consumer triggers a search request through the application or portal on the CareMed Web Site
5. Request search string locates providers (real-time) within the locale of the consumer stored within the CareMed meta data repository
6. Clinics interested will provide CareMed with availability requirements
7. Results are presented based on multiple criteria decision analysis
8. Consumer selects a suitable clinic
9. Confirmation is provided in real time between clinic and consumer brokered by CareMed via secured SMS, or
10. Confirmation is provided in real time between clinic and consumer brokered by CareMed via secure Chat—Instant Messaging
11. Directions to the selected clinic is provided

### Benefits

1. Only clinics presented to the consumer with guaranteed availability slots for ad hoc appointments are presented minimizing the number of clinics presented to a consumer
2. Communication gateway established may facilitate further QA session
3. Patient satisfaction increases
4. Providers presented to the consumer will have an increased number of appointments scheduled—increased revenue

Scenario 3: Utilizing SMS, Chat or Video
1. CareMed application is deployed to the mobile phones of consumers via a self service portal
2. Meta data is captured for all care providers (viz. demographics) and processed and stored within CareMed
3. Meta Data is regularly refreshed, cleansed and updated
4. Consumer triggers a search request through the application or portal on the CareMed Web Site
5. Request search string locates providers (real-time) within the locale of the consumer stored within the CareMed meta data repository
6. Clinics interested will provide CareMed with availability requirements
7. Results are presented based on multiple criteria decision analysis
8. Consumer selects clinic that meet the needs of the consumer
9. Directions to the selected clinic is provided
10. Confirmation is provided in real time between clinic and consumer brokered by CareMed via secured SMS, or
11. Confirmation is provided in real time between clinic and consumer brokered by CareMed via secured Instant Messaging, or
12. Interaction is facilitated via video session

### Benefits

1. Only clinics presented to the consumer with guaranteed availability slots for ad hoc appointments are presented minimizing the number of clinics presented to a consumer
2. Communication gateway established may facilitate a QA session
3. Patient satisfaction increases
4. Providers presented to the consumer will have an increased number of appointments scheduled—increased revenue

### Scenario 4: Consumer is Registered with CareMed

1. CareMed application is deployed to the mobile phones of consumers via a self service portal
2. Meta data is captured for all care providers (viz. demographics) and processed and stored within CareMed
3. Meta Data is regularly refreshed, cleansed and updated
4. Consumer triggers a search request through the application or portal on the CareMed Web Site
5. Request search string locates providers (real-time) within the locale of the consumer stored within the CareMed meta data repository
6. Clinics interested will provide CareMed with availability requirements
7. Payer information is provided upon consumer providing insurance information
8. Results are presented based on multiple criteria decision analysis
9. Consumer selects clinic
10. Directions to the selected clinic is provided
11. Confirmation is provided in real time between clinic and consumer brokered by CareMed via secured SMS
12. Confirmation is provided in real time between clinic and consumer brokered by CareMed via secured Instant Messaging
13. Interaction is facilitated via video session
14. Consumer is provided with the location of local pharmacies including potential discounts and other commercial incentives

### Benefits

1. Only clinics presented to the consumer with guaranteed availability slots for ad hoc appointments are presented minimizing the number of clinics presented to a consumer
2. Clinics suggested are payer sanctioned or approved
3. Claims processing is timely
4. Patient satisfaction increases
5. Communication gateway established may facilitate a QA session
6. Providers presented to the consumer will have an increased number of appointments scheduled—increased revenue
7. Payer claims dispute reduced—increased consumer satisfaction

### CareMed Infrastructure

The CareMed infrastructure Architecture comprises of five technology domains [1] Delivery Channels—detailing all actors within the CareMed ecosphere,[2] Internet security, [3] Web Services and Data-Messaging Service Bus. [4] Data Repository providing application business logic and analytics features and, [5] Secure Communications broker.

### Delivery Channels

Delivery channels domain is an ecosystem of entities that form a dynamic loosely coupled relationship. It consists of consumer (anonymous or registered-known) providers (medical, dental, vision), payers (insurance) and pharmacy. Whilst CareMed operates independent of any affiliation, it requires the installation of specific software to facilitate search and secure communication. The software stack comprises of the following:
1. Mobile application
2. Web client application
3. A software agent (or API) is installed with Providers, Payers and Pharmacies to establish a secure VPN connection enabling the exchange of information including SMS, IM and VIDEO.
4. A provider, payer and pharmacy secure portal is also available to allow them to maintain their respective Meta Data if required
5. All software deployed on consumer, provider, payer and pharmacy will be digitally signed to ensure authenticity (non-repudiation)
6. No PII or HIPPA data is stored within CareMed
7. Consumers registered with CareMed will not be used outside CareMed.

### Infrastructure Security

CareMed is hosted within an approved IaaS provider. Security is provided for access, authentication, and authorization. Security offered is multilayered providing encryption of data and rest and in motion. Due to the binding of connections between all parties an encrypted secure tunnel is required preventing the interception of data flow between entities or tunneling of malicious attacks between entities. The goal of the security stack is to prevent malicious attacks originating at any entity and propagating across the CareMed ecosphere

### CareMed services

The CareMed services comprise of six foundational components
1. Identity Services—manages all identities within the CareMed ecosphere to ensure validation and verification of all players engaged. If consumers are registered the identity services ensures the validity of the consumer
2. Portal Web Services—a portal that allows all entities to directly connect with CareMed hosting services. It mirrors the functionality of the mobile application for consumers. Provides access to clinics, payers and pharmacy
3. Messaging Web Services—manages all web services or APIs placed within the CareMed ecosphere. Evaluates and determines availability of all agents and APIs
4. Web Services Repository—container of all verified software agents, APIs, and mobile applications includes digital signing to verify authenticity
5. Meta Data Search Engine—application that scans websites and extracts provider data for use within CareMed. Prior to inclusion into MCDA engine a validation or verification step is taken (enrollment process)
6. Communication Gateway—manages all communication between CareMed and consumers and partners

### Service Bus and Applications

The service bus facilitates rapid real time exchange of data between all entities involved in the interaction. It binds all of the applications to the applications residing with consumers, providers, and payers (including pharmacy). This domain consists of applications and data repositories as follows:
1. Repositories
   a. Analytical—this is the data set that drives the MCDA engine
   b. Operational Data—this is data used to run CareMed, i.e. referential data
   c. Unstructured Data—this is data that cannot be normalized within the database that us used for MCDA computational analysis
   d. Meta Data—this contains the validation and verification rules of all data used in CareMed
2. Operational Services—these are back-office systems used to run CareMed (landscape systems management, software management and life cycle, messaging, and directory services)
3. CareMed Application Services—this is CareMed application and business logic. It contains the MCDA propriety algorithms.

### PaaS—SaaS Services

This domain leverages third party providers in a wide range of services viz. application, hosting and communication services. It is not the intention of CareMed to develop these services as they are considered commodities. The constraint to selecting the right partner is security, legal, regulatory and compliance requirements.

### Multi Criteria Decision Analysis Specification

The algorithm used by CareMed National Walk-In Medical Clinical Locator to determine recommendations made to consumers is based upon an established and proven concept called multi criteria decision model (MCDM). The model attempts to resolve conflicts among competing decision attributes and manage differing units of measures (i.e. incommensurate units). The computational model considers a range of unique and propriety healthcare-specific criteria based upon whether the consumer is anonymous or known to the CareMed system (up to a maximum of 13 criteria). The criteria are weighted appropriately (the weighted values are normalized to a value of 1). The selection (a scalar value) is ranked in order of preference based on the circumstance at that time of the enquiry. The model compares the decision attributes for each weighted criteria against each alternative.

MCDM model used is based either upon an A=[M×N] matrix (anonymous user) or R=[Q×P] matrix (registered user) in which element aᵢⱼ indicates the performance of an alternative Aᵢ when evaluated in terms of decision criterion Cⱼ, for i=1,2,3 . . . M, and j=1,2,3 . . . N

$$\begin{matrix} & {C}_{1} & {C}_{2} & {C}_{3} & … & {C}_{N} \\ Alternatives & {W}_{1} & {W}_{2} & {W}_{3} & … & {W}_{N} \\ {A}_{1} & {a}_{11} & {a}_{12} & {a}_{13} & … & {a}_{1 N} \\ {A}_{2} & {a}_{21} & {a}_{22} & {a}_{23} & … & {a}_{2 N} \\ {A}_{3} & {a}_{31} & {a}_{32} & {a}_{33} & … & {a}_{3 N} \\ ⋮ & & & & & \\ {A}_{M} & {a}_{M 1} & {a}_{M 2} & {a}_{M 3} & … & {a}_{MN}\end{matrix}$$

Each decision criteria is weighted appropriately relative to the performance of the decision criteria Wⱼ, for j=1,2,3 . . . N. The suggestions are then compared to a finite number of alternatives.

A further set of calculations is performed against the suggested alternatives mapping the results to the ideal solution (A⁺) or negative-ideal solution (A⁻). The alternative Aᵢ that maps closest to the ideal is presented to the consumer.

The following section outlines two sets of computational models [1] weighted product model and [2] order preference by similarity to the ideal both are used for either an anonymous consumer or known (registered) consumer.

### MCDM Model—Anonymous User

Multi criteria decision model weighted product model for anonymous users relies on eight criteria (C_{N}) or attributes for ranking in order of preference or relevance the suggested clinics (A_{M}=Alternative). Weighting (W_{N}) for the criteria will total to the value of 1 (i.e. W =W₁+W₂+W₃ . . . W_{N}=1). Available criteria are listed below. The matrix holds single dimension values,

C₁=Distance in miles from current location to clinic (xx.xxx miles)

C₂=ETA in minutes to the clinic (mm.mmm minutes)

C₃=Variance to requested day-time (delta Δ in, hours hh.hhh)

C₄=KPI customer rating of clinic (value 1 to 5, where 5 is highest performing, absolute value [k])

C₅=Speed to respond to request enquiry (value ss.sss in ms)

C₆=Appointments tallied (number of times clinic has responded to enquiry absolute value [t])

C₇=Services provided by clinic (added value service, basic (1) to advance (5))

C₈=CareMed registered clinic (Yes [1] or No [2] respectively, absolute values)

Alternative or suggested clinics is defined in terms of A_{M}

Due to the number of competing and alternative recommendations, each alternative is compared with others in the ranking. Expressed mathematically as

$$R ( {A}_{K} / {A}_{L} ) = {\sum }_{J = 1}^{N} {( {a}_{Kj} / {a}_{Lj} )}^{wj}$$

Where A_{K} and A_{L} represent two recommended alternatives, N is the number of criteria and W is the weight of importance. The model is dimensionless as it ignores the unit of measures within the suggested alternatives. For a discrete alternative A_{M}, R is expressed as follows

R(A₁/A₂)=(a₁₁/a₂₁)^{w1}*(a₁₂/a₂₂)^{w1}* . . . *(a_{1N}/a_{2N})_{WN}

If the computational value of R (A_{K}/A_{L}) is greater than one, A_{K} is preferred over A_{L}, therefore the best alternative over a range of A_{M} is one that is better than or at least equal to all the other alternatives.

Multi criteria decision model that computes order preference by similarity to the ideal is applied to the top 5 recommendations. In this model a Euclidean distance approach identifies the closest alternative to the ideal (A⁺) and the furthest to the ideal (A⁻). The decision matrix is converted into a normalized and weighted normalized decision matrix (V). The determination of the ideal (max A⁺) and negative-ideal (min A⁻) is shown below:

A⁺={(maxvᵢⱼ|jεJ′)|i=1,2,3,4 . . . M}=i

A⁻={(minvᵢⱼ|jεJ), (maxvᵢⱼ|jεJ′)|i=1,2,3,4, . . . M}=i

Where J is the associated benefit criteria and J′ is the associated “cost” criteria or least preference. The element vᵢⱼ is the weighted element of aᵢⱼ. The relative closeness (C) to the ideal solution is expressed as:

Cᵢ₊=Sᵢ₋/(S₁₊+Sᵢ₋) where S is the separation distance to the ideal. S₊represents the closest and S₋ the farthest to the ideal.

Sᵢ₊=√Σ(vᵢⱼ−vⱼ₊)² and Sᵢ₋=√(Σ(vᵢⱼ−vⱼ₋)²

### MCDM Model—Registered User

Multi criteria decision model weighted product model for registered users relies on thirteen criteria (C_{N}) or attributes for ranking in order of preference or relevance the suggested clinics (A_{M}=Alternative). Weighting (W_{N}) for the criteria will total to the value of 1 (i.e. W=W₁+W₂+W₃ . . . W_{N}=1).

Decision criteria—variables is listed below. The matrix holds single dimension values,

C₁=Distance in miles from current location to clinic (xx.xxx miles)

C₂=ETA in minutes to the clinic (mm.mmm minutes)

C₃=Variance to requested day-time (delta Δ in, hours hh.hhh)

C₄=KPI customer rating of clinic (value 1 to 5, where 5 is highest performing, absolute value [k])

C₅=Speed to respond to request enquiry (value ss.sss in ms)

C₆=Appointments tallied (number of times a clinic has responded to s consumer's enquiry, absolute value [t])

C₇=Services provided by clinic (added value service, basic (1) to advance (5))

C₈=CareMed registered clinic (Yes [1] or No [2] respectively, absolute values)

C₉=User is registered with CareMed (Yes [1] or No [2] absolute values)

C₁₀=Payer Information known (Yes [1] or No [2] respectively, absolute values)

C₁₁=Clinic is IN-NET or OUT-OF-NET ([1] or [2] respectively, absolute values)

C₁₂=Payer approved visit (Yes [1] or No [2] respectively, absolute values)

C₁₃=Wait times of clinic (mm.mmm minutes)

1. Computational Analysis
Vast amount of nation-, state- and provincial-wide consumer behavior in the form of requests for service, location, and appointment times is captured for strategic and competitive analysis and provides insight into trends and illness important for understanding community health and important to identify emerging trends.
The MCDA algorithm provides multiple ways to make informed decisions that guide choices made by the consumer. The algorithm is consumer centric and not provider centric model and does not assume any relationship between consumer and provider. It leverages up to thirteen unique variables to improve the consumer's decision model. Included within the multiple variables is the voice of the consumer that may affect the weighted ranking of providers. Conversely search engines provide only results of an enquiry without context i.e. unguided.
The analytical engine brokers consumer-provider interaction via a secure universal communication hub. This method augments the weighted recommendations provided by the MCDA model by facilitating an ad hoc unstructured dialogue.

2. Networked Provider Base
The analytical engine provides a nation-wide valuable provider directory beyond demographic data found in many search engines of the day. Key operational and performance data is captured. This data in conjunction with de-identifiable consumer data is made available to providers (for a fee) to allow them to reposition their offering, service lines, locations, and provider skills-mix. The data collected and analyzed provide significant strategic and market value.

3. Community Health
Increasing access to providers and increasing the knowledgebase of providers' network coupled with improved decision models that guide consumers would reduce stress experienced within Hospital ED departments. Consumers would be directed to non-ED departments or clinics.
